(19) United States
(12) Patent Application Publication
(10) Pub. No.: US 2016/0267093 A1
(43) Pub. Date: Sep. 15, 2016

(54) GEOLOCATION AND PRACTICE SETTING BASED TRAINING FILTERING

(71) Applicant: Andres Jimenez, Dallas, TX (US)

(72) Inventor: Andres Jimenez, Dallas, TX (US)

(21) Appl. No.: 15/067,213

(22) Filed: Mar. 11, 2016

Related U.S. Application Data
(60) Provisional application No. 62/131,866, filed on Mar. 12, 2015.

(51) Int. Cl. G06F 17/30; G06N 99/00; H04L 29/08

(52) U.S. Cl. CPC G06F 17/3087; G06F 17/30241; H04L 67/18; G06F 17/30867; G06N 99/005

(57) ABSTRACT

Systems and methods for suggesting geolocation-based mobile solutions are described herein. An example method can commence with receiving, from a mobile device, indicia of a mobile application being launched. The method may further include receiving a location associated with the mobile device. The location may be matched to a practice setting in a database. The method may further include ascertaining organization parameters and user parameters associated with a user of the mobile device. Based on the practice setting, the user parameters, and organization parameters, at least one mobile solution may be suggested.

### CROSS-REFERENCE TO RELATED APPLICATIONS

The present utility patent application is related to and claims priority benefit of the U.S. provisional application No. 62/131,866, filed on Mar. 12, 2015 under 35 U.S.C. 119(e). The contents of the provisional application are incorporated herein by reference for all purposes to the extent that such subject matter is not inconsistent herewith or limiting hereof.

### TECHNICAL FIELD

The present disclosure relates generally to data processing and, more particularly, to methods and systems for suggesting geolocation-based mobile performance support and training.

### BACKGROUND

Current work environments can be increasingly demanding on medical professionals. There are multiple changes occurring in all professional spheres, including policy changes, emergence of new technologies, transitions to new management systems, and so forth. Although training that occurs prior to when the individual is asked to perform using the new knowledge (i.e., before implementation of an Electronic Health Record (EHR)) is critical to performance of the new skills (i.e., using the EHR), the amount of time a busy professional can spend on training is limited, and the effectiveness of pre-implementation training is very limited. Additionally, training needs may be different even across individuals from the same specialty, which will perform in different practice settings, and the mix of performance across the individuals within a large organization can be highly variable. Furthermore, professional learners may need a flexible and self-paced training method available at any time or location, with the ability to prioritize training reviewed by a learner, so it is more contextual, and thus meaningful. Moreover, the training is a continuous process rather than a single event. The learner may need to revisit the training repeatedly at various stages and at optional times or while at certain locations.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are systems and methods for suggesting geolocation-based performance support mobile solutions or mobile trainings, also referred herein to as geolocation-based mobile solutions or mobile trainings. An example method may commence with receiving indicia of a mobile application being launched. The indicia may be received from a mobile device associated with the user. The method may further include receiving a location associated with the mobile device. The location of the mobile device may be received via location services associated with the mobile device.

Furthermore, the method may include matching the location to a practice setting in a database, either directly or through the use of a dynamic geofence. The practice setting may include a specialization field of the user, an area of practice of the user corresponding to a sub-population of the usual patient population (and corresponding conditions and procedures), and a type of organization associated with the user. An example practice setting may include an academic hospital, a rural hospital, an ambulatory clinic, a rehabilitation center, a pediatric hospital, and the like. The dynamic geofence may be dynamically created or adjusted based on the type of the practice setting and additional parameters for the site, such as the number of physicians. The practice setting and the dynamic geofence corresponding to the practice setting may be adjusted using variables that characterize the size associated with the hospital or clinic, such as the number of beds, number of affiliated physicians, eligible providers, and so forth. Additionally, the practice setting may be adjusted based on publicly reported quality or performance scores of the hospital or clinic. Furthermore, the practice setting and location associated with a mobile device, such as a GPS location, may be adjusted using local positioning tools, such as beacons, that may add local positioning context to the practice setting.

The method may include ascertaining user parameters associated with a user of the mobile device. The user parameters may include one or more of the following: a user role, a user specialty, an initial setup, a number of logins, historical user input, user preferences, user favorites, user likes, user tags, and so forth.

The method may include suggesting at least one mobile solution. The mobile solution may include training. The suggestion can be made based on the practice setting and the user parameters. The suggestions may include matching the user parameters to further user parameters associated with the practice setting. The further user parameters may correspond to further users associated with the practice setting regardless of the location.

The method may further include receiving a search request from a user. The user may request a specific training in the search request. If a search match is found, the search match may be registered for the mobile solution based on the practice setting associated with the user. Furthermore, the user may mark the mobile solution by pressing a “Like” button. If the mobile solution is liked by the user, the mobile solution may be registered based on the practice setting associated with the user. Additionally, the user may add the mobile solution to a favorite list of mobile solutions. If the mobile solution is added to the favorite list of mobile solutions, the mobile solution may be registered based on the practice setting associated with the user.

The method may include identifying at least one learner matching the practice settings and the user parameters. Based on preferences of the at least one learner with similar parameters, the at least one mobile solution may be suggested to the at least one learner.

### BRIEF DESCRIPTION OF THE DRAWINGS

Embodiments are illustrated by way of example and not limitation in the figures of the accompanying drawings, in which like references indicate similar elements and, in which:

FIG. 1 illustrates an environment within which systems and methods for suggesting geolocation-based mobile solutions can be implemented, in accordance with some embodiments.

FIG. 2 is a block diagram showing various modules of a system for suggesting geolocation-based mobile solutions, in accordance with certain embodiments.

FIG. 3 is a flow chart illustrating a method for suggesting geolocation-based mobile solutions, in accordance with some example embodiments.

FIG. 4 shows a schematic diagram of providing mobile solutions, in accordance with some example embodiments.

FIG. 5 shows a schematic diagram of providing mobile solutions, in accordance with some example embodiments.

FIG. 6 shows an example list of mobile solutions suggested to a user, in accordance with some example embodiments.

FIG. 7 shows a schematic diagram of tagging mobile solutions, in accordance with some example embodiments.

FIG. 8 is a schematic diagram showing a search for a mobile solution, in accordance with some example embodiments.

FIG. 9 is a schematic diagram showing suggesting a mobile solution to further users, in accordance with some example embodiments.

FIG. 10 is a schematic diagram showing dynamic creation of a geofence for a specific location and practice setting, in accordance with some example embodiments.

FIG. 11 shows a diagrammatic representation for providing mobile solutions based on a location of a user, in accordance with some example embodiments.

FIG. 12 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

This disclosure provides methods and systems for suggesting mobile performance support solutions based on a geolocation of a mobile device associated with a user and further based on practice settings of the user. The methods and systems may assist professionals in meeting learning requirements in changing environments. Upon launch of a mobile application on the mobile device, the current geolocation of the user may be identified. As used herein, the term “geolocation” can also be referred to as “location.” The current geolocation can be matched to geolocations in a database to determine a practice setting of the user. The practice setting may include a specialized field of the user, an area of practice of the user, a type of organization associated with the user, and the like. The example practice setting may include an academic hospital, a rural hospital, an ambulatory clinic, a rehabilitation center, and so forth. Furthermore, user parameters associated with the user of the mobile device can be ascertained. The user parameters may include one or more of the following: a user role, a user specialty, an initial setup, a number of logins, historical user input, user preferences, user favorites, user tags, and so forth. The user parameters may be entered by the user during the initial setup of the mobile application, first launch of the application, first time a user logs in, and the like. Based on the practice setting and the user parameters, a list of mobile solutions, such as trainings, can be suggested to the user.

The suggesting of the mobile solution may also include matching the user parameters to further user parameters. The further user parameters may correspond to further users associated with the same practice setting regardless of the geolocations of the further users.

Furthermore, according to the method, the user may provide a search request to find a particular topic (with the assumption that the particular topic is relevant to the current practice setting). The user can also browse for a particular mobile solution based on current needs of the user. Upon receiving of the search request, the search may be performed. If a match is found based on the geolocation of the user, the search match may be registered for this mobile solution and provided to the user.

All registered search matches can be captured for the specific mobile solution. The found mobile solutions may then be used to suggest mobile solutions to further users in the future for learners that match the practice setting and have similar user parameters, such as role, specialty, and so forth, and similar parameters associated with the practice setting that refer to an organization associated with learners, such as publicly reported quality scores and performance scores of the organization. Users from different organizations in different locations may have access to the same library of mobile solutions, and, although addresses of locations are different, the similar practice settings may be the common denominator used to suggest the mobile solution to users from different locations.

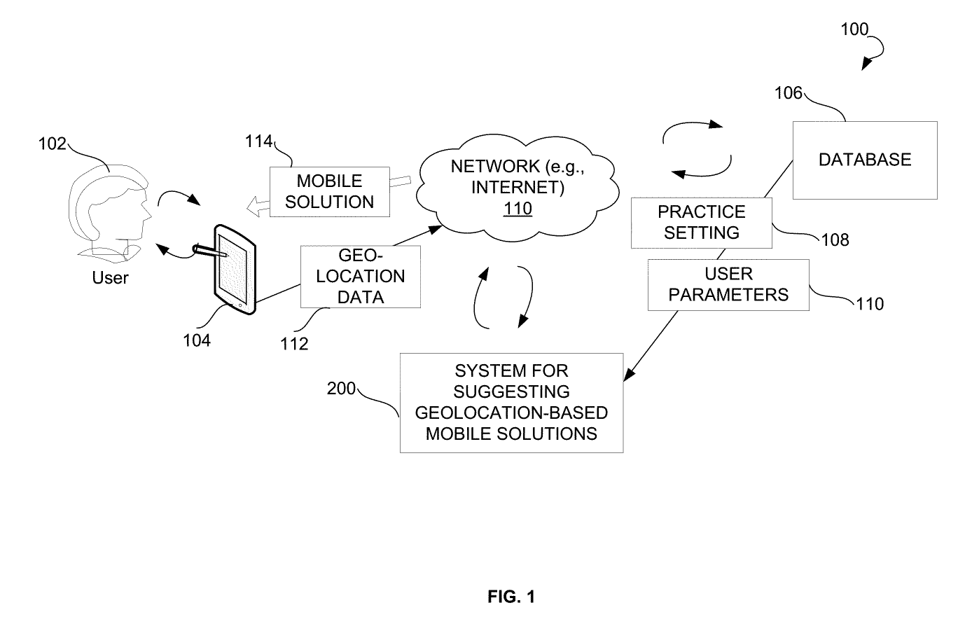

FIG. 1 illustrates an environment 100 within which systems and methods for suggesting geolocation-based mobile solutions can be implemented, in accordance with some embodiments. An example system 200 for suggesting geolocation-based mobile solutions can include a server-based distributed application. Therefore, the system 200 may include a central component residing on a server and one or more client applications residing on work stations and communicating with the central component via a network. A user 102 may communicate with the system 200 for suggesting geolocation-based mobile solutions via a client application available through a client device 104 (for example, a mobile device, such as a smart phone, a tablet personal computer (PC), a laptop, and so forth).

The user 102 may be associated with an enterprise; for example, the user 102 can be an employee of an organization. The organization may use the system 200 for suggesting geolocation-based mobile solutions to provide certain skill trainings and to improve certain performance areas of users. The system 200 for suggesting geolocation-based mobile solutions may be used by organizations across all industries, including healthcare, financial, technology, utilities, consumer goods, services, and other industries. In an example embodiment, the user 102 may be a healthcare professional (e.g., a physician, a surgeon, a nurse, and the like). The organization utilizing skills of the user 102 may include a healthcare organization such as, for example, a clinic, a hospital, a laboratory, an institution, and so forth.

A high skill level of users is very important because the United States healthcare system, for example, is moving from a volume-based compensation model to a quality-based compensation model to better align the quality of care delivered and patient outcomes with reimbursement. Central to this is the use and standardization of performance metrics, which may utilize a numerator/denominator format with exclusion criteria that can be benchmarked nationally to compare quality of care delivered. The National Quality Forum is an example of standardized measures that are evidence-based and consistent with national initiatives to foster quality improvement in public and private sector healthcare organizations. Physicians are the key drivers of medical decisions in healthcare that impact patient outcomes, along with mid-level providers and other clinical staff that ultimately impact organizational-based, and individual provider-based, performance metrics and quality metrics. Performing well on these measures requires knowledge and understanding of the measured details (numerator, denominator, and exclusion criteria), supporting evidence, and management of patient disease. Furthermore, since reporting on most of these measures is mediated in recent times through the use of electronic medical/health record type enterprise applications, correct and accurate use of electronic medical/health record systems as it pertains to the quality measures is necessary for accurate collection of data, reporting of performance, and good overall performance. These performance measures are related to initiatives such as meaningful use, value-based purchasing, merit-based incentive payment system, alternative payment models, accountable care organizations, patient centered medical homes, and other types of healthcare initiatives aimed at improving patient outcomes.

The system 200 for suggesting geolocation-based mobile performance support solutions may receive geolocation data 112 from the client device 104 associated with the user 102. Furthermore, the system 200 for suggesting geolocation-based mobile solutions may receive user related data, such as user parameters 110 and practice setting 108, from a database 106 associated with the system 200 for suggesting geolocation-based mobile solutions. The practice setting 108 of the user 102 may be retrieved from the database 106 based on geolocation data 112 of the user 102. The user parameters 110 may be entered by the user 102 during the initial setup of the mobile application associated with the client device 104, first launch of the mobile application, first time a user logs in, and the like. The system 200 for suggesting geolocation-based mobile solutions may receive geolocation data 112 from the client device 104 associated with the user 102. Based on received geolocation data 112, practice setting 108, and user parameters 110, the system 200 for suggesting geolocation-based mobile solutions may suggest a mobile solution 114 to the user 102. In an example embodiment, the system 200 further receives organization parameters. The organization parameters may include local positioning context, quality scores, and performance scores associated with the organization. The local positioning context may be received via local positioning tools, such as a beacon for example. The beacon may include a beacon that uses iBeacon™ protocol, also referred to as an iBeacon, and other types of beacons. The quality scores and performance scores may include, for example, high infection rates within a particular unit of the organization. In some embodiment, a suggestion for the mobile solution 114 may be further based on the local positioning context, quality scores, and performance scores. The mobile solution 114 may include training. In an example embodiment, the training may consist of training sessions, which may contain video files, audio files, text files, pictures, references to resources, and so forth.

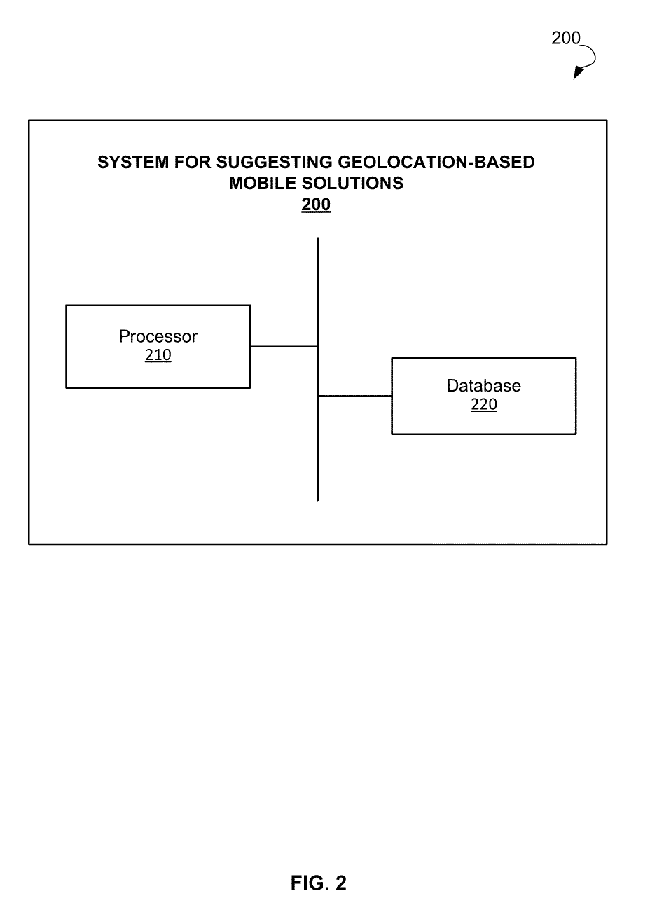

FIG. 2 is a block diagram showing various modules of a system 200 for suggesting geolocation-based mobile solutions, in accordance with certain embodiments. The system 200 may include a processor 210 and a database 220. The database 220 may include computer-readable instructions for execution by the processor 210. The processor 210 may include a programmable processor, such as a microcontroller, central processing unit (CPU), and so forth. In other embodiments, the processor 210 may include an application-specific integrated circuit or programmable logic array, such as a field programmable gate array, designed to implement the functions performed by the system.

In various embodiments, the system 200 may be deployed within the network of an organization or reside outside of the organization in a data center outside of the organization's control and be provided as a cloud service. By residing in a cloud storage, the system 200 may be able to include a marketplace of venues, not just the venues under control of the organization.

The processor 210 may be operable to receive indicia of a mobile application being launched. The indicia may be received from a mobile device associated with the user. The processor 210 may be further operable to receive a location associated with the mobile device. The location of the mobile device may be received via location services associated with the mobile device.

Furthermore, the processor 210 may be operable to match the location to a practice setting in a database. The practice setting may include a specialization field of the user, an area of practice of the user, a type of organization associated with the user, a type of organization located in the location, and the like. Example practice settings may include an academic hospital, a rural hospital, an ambulatory clinic, a rehabilitation center, and the like.

The processor 210 may be operable to ascertain user parameters associated with a user of the mobile device. The user parameters may include one or more of the following: a user role, a user specialty, an initial setup, a number of logins, historical user input, user preferences, user favorites, user tags, user likes, and so forth.

The processor 210 may be operable to suggest at least one mobile solution. The suggestion can be made based on the practice setting, the user parameters, and the organization parameters. In an example embodiment, the suggesting may include matching the user parameters to further user parameters associated with the practice setting. The further user parameters may correspond to further users associated with the practice setting regardless of the location of the further users.

In an example embodiment, the processor 210 may be further operable to receive search requests from a user. The user may request a specific training. If a search match is found, the search match may be registered for the mobile solution based on the practice setting associated with the user. In an example embodiment, the user may “Like” the mobile solution. If the mobile solution is liked by the user, the mobile solution may be registered based on the practice setting associated with the user. Additionally, the user may add the mobile solution to a favorite list of mobile solutions and/or “like” the mobile solution. If the mobile solution is added to the favorite list of mobile solutions, the mobile solution may be registered based on the practice setting associated with the user.

In an example embodiment, the processor 210 may be further operable to identify at least one learner matching the practice settings and the user parameters. Based on preferences of the at least one learner having similar parameters, the at least one mobile solution may be suggested to the at least one learner.

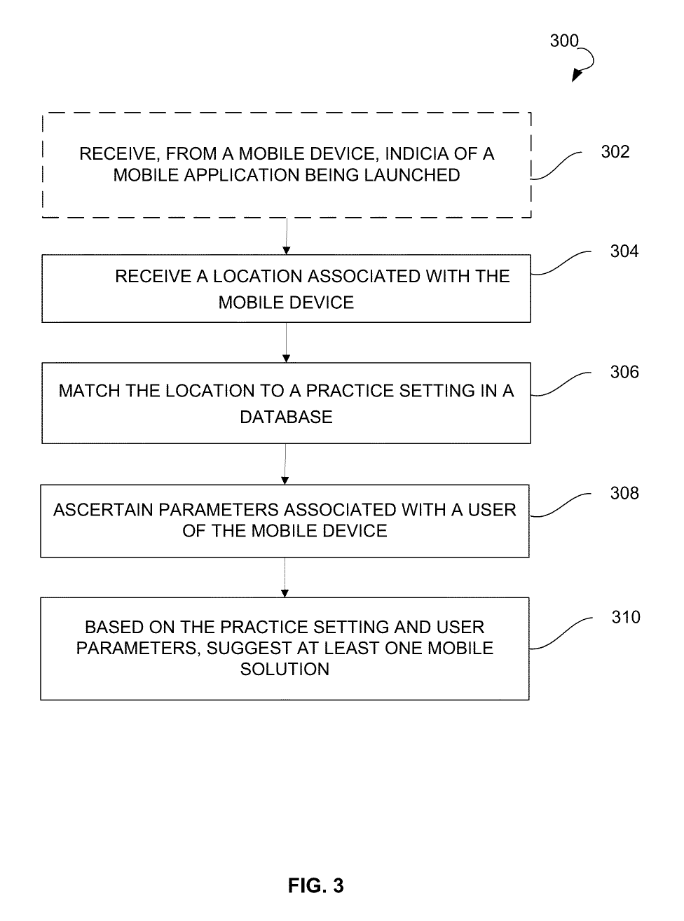

FIG. 3 is a flow chart illustrating a method 300 for suggesting geolocation-based mobile solutions, in accordance with some example embodiments. The method 300 may commence with receiving indicia of a mobile application being launched at optional operation 302. The indicia may be received from a mobile device associated with the user. The method 300 may further include receiving a location associated with the mobile device at operation 304. The location of the mobile device may be received via location services associated with the mobile device, such as a Global Positioning System.

Furthermore, the method 300 may include matching the location of the user to a practice setting in a database at operation 306. The practice setting may include a specialization field of the user, an area of practice of the user, a sub-population of patient population, a type of organization associated with the user, local positioning context provided via local positioning tools, performance scores associated with an organization, quality scores associated with an organization, and the like. An example practice setting may further include an academic hospital, a rural hospital, an ambulatory clinic, a rehabilitation center, and the like.

The method 300 may include ascertaining user parameters associated with the user of the mobile device at operation 308. The user parameters may include one or more of the following: a user role, a user specialty, an initial setup associated with the mobile application or a user profile, a number of logins, historical user input, user preferences, user favorites, user tags, user likes, user performance, such as performance metrics associated with the user, for example, performance scores or quality scores related to patients associated with the user, productivity of the user, and so forth.

The method 300 may include suggesting at least one mobile solution at operation 310. The suggestion can be made based on the practice setting and the user parameters. In an example embodiment, the suggesting may include matching the user parameters to further user parameters associated with the practice setting. The further user parameters may correspond to further users associated with the practice setting regardless of the location.

In an example embodiment, the method 300 may further include receiving a search request from a user. The user may request a specific training in the search request. If a search match is found, the search match may be registered for the mobile solution based on the practice setting associated with the user. In an example embodiment, the user may “Like” the mobile solution. If the mobile solution is liked by the user, the mobile solution may be registered based on the practice setting associated with the user. Additionally, the user may add the mobile solution to a favorite list of mobile solutions. If the mobile solution is added to the favorite list of mobile solutions, the mobile solution may be registered based on the practice setting associated with the user.

In an example embodiment, the method 300 may include identifying at least one learner matching the practice settings, the user parameters, and organization parameters. Based on preferences of the at least one learner with similar parameters, the at least one mobile solution may be suggested to the at least one learner.

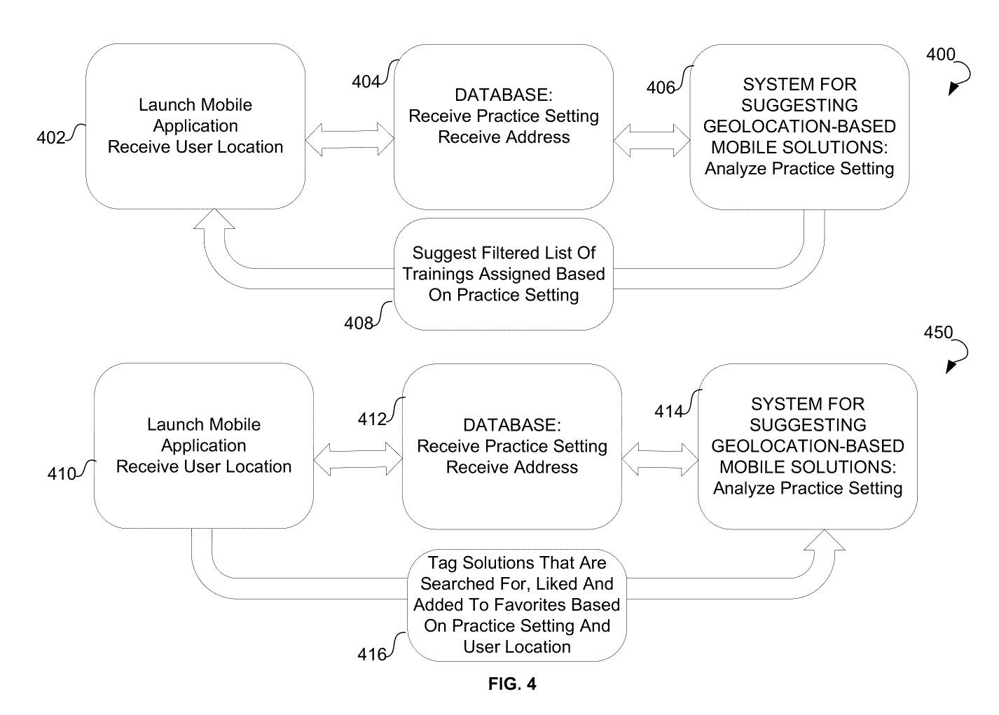

FIG. 4 shows a schematic diagram 400 of providing mobile solutions by a system for suggesting geolocation-based mobile solutions. Upon launch of a mobile application on a mobile device associated with the user, the system may receive the geolocation of the user, as shown in block 402. Additionally, the system may create a dynamic geofence on the practice setting and additional parameters for a site, such as a number of physicians. Upon receiving the geolocation, the system may check the database to receive a practice setting associated with the user, such as an academic hospital, rural hospital, ambulatory clinic, rehabilitation center, and so forth, or an address associated at a practice setting, as shown in block 404. The system may analyze the practice setting of the user to filter mobile solutions available in the database for such a practice setting, as shown in block 406. In example embodiments, the analysis may include analyzing publicly reported quality scores or performance scores associated with an organization, as well as local positioning context provided by local positioning tools, such as an iBeacon. Based on the analysis, the system may suggest a filtered list of mobile solutions (e.g., available trainings), as shown in block 408. Therefore, the list of mobile solutions is selected based on the geolocation and further based on the practice setting of the user.

FIG. 4 further shows a schematic diagram 450 of performing a search by a system for suggesting geolocation-based mobile solutions based on a search request of the user. According to another example embodiment, the user may search for a specific mobile solution. Upon receiving the search request, the system may request data related to the current geolocation of the user, as shown in block 410. The mobile device may provide data on the current geolocation of the user to the system. Upon receiving the geolocation, the system may check the database to retrieve a practice setting associated with the user, as shown in block 412. The system may analyze the practice setting of the user to filter mobile solutions available in the database, as shown in block 414. Based on the analysis, the system may suggest a specific mobile solution or a list of specific mobile solutions. Upon receiving the specific mobile solution, the user may mark the specific mobile solution by pressing a “Like” button. Furthermore, the user may add the specific mobile solution to a favorite list of mobile solutions, for example, by pressing a “Favorite” button. Based on the organization parameters and the user parameters, such as user performance, both the liked mobile solutions and the favorite mobile solutions may be tagged to the practice setting of the user, as shown in block 416. In some embodiments, the liked or favorite mobile solutions may be further tagged based on the current geolocation of the user and the search request of the user. The tagged mobile solutions may be suggested in the future to further users who have a similar practice setting, but not necessarily the same geolocation, as the practice setting may be a key element in finding and suggesting the mobile solutions.

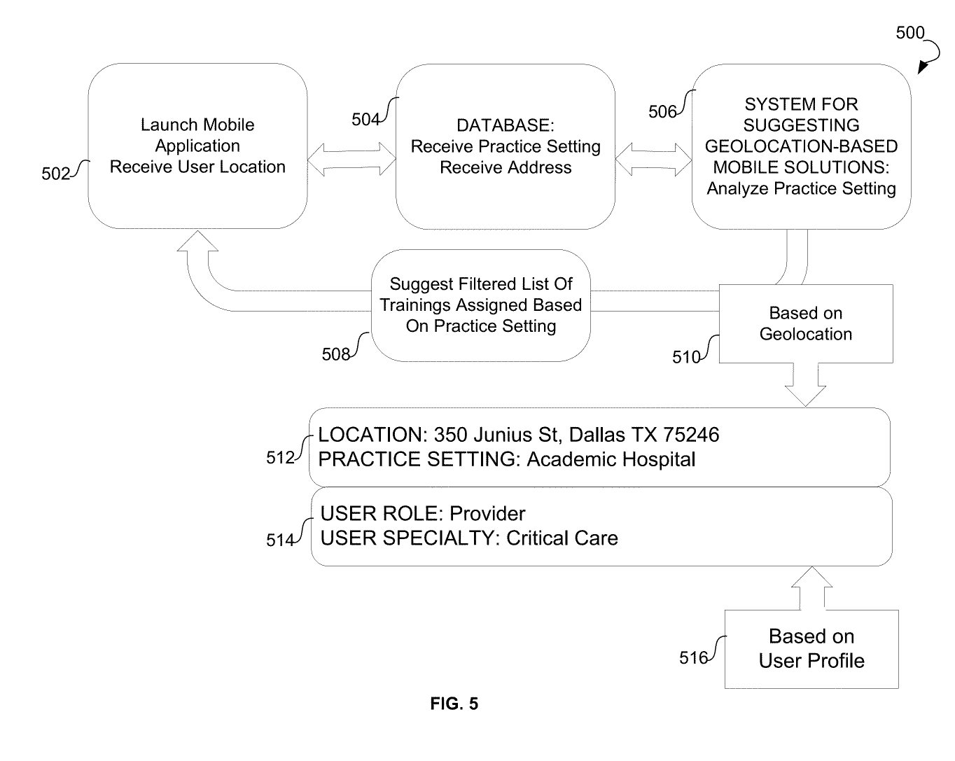

FIG. 5 shows a schematic diagram 500 of mobile solutions provided by a system for suggesting geolocation-based mobile solutions based on the analysis of the practice setting and location of the user. As shown on the schematic diagram 500, the current location of the user may be received and matched with the database to determine the current practice setting, as shown in blocks 502, 504. The analysis may be performed based on the location and the practice setting, e.g., an academic hospital, and a specific mobile solution may be provided to the user, as shown in blocks 506, 508. In some example embodiments, the analysis may be based on publicly reported quality scores or performance scores associated with an organization, as well as local positioning context provided by local positioning tools, such as iBeacons. The analysis may be based on factors or variables associated with the size of the organization, such as the number of affiliated physicians, and number of beds. More specifically, the analysis may be performed based on geolocation of the user, as shown in blocks 510 and 512, and based on a user profile, as shown in blocks 514 and 516. Based on user parameters, for example, settings of a user profile such as role of the user (e.g., provider), specialty of the user (e.g., critical care), user performance, and the like, another specific mobile solution may be provided to the user. The user may provide data to the user profile during the initial setup of the mobile application, upon first log in of the user into the mobile application, or upon request of the mobile application, to designate role and specialty of the user. In some example embodiments, the data associated with the user performance may be provided by the organization and publicly reported performance data associated with the user may be added to the user profile.

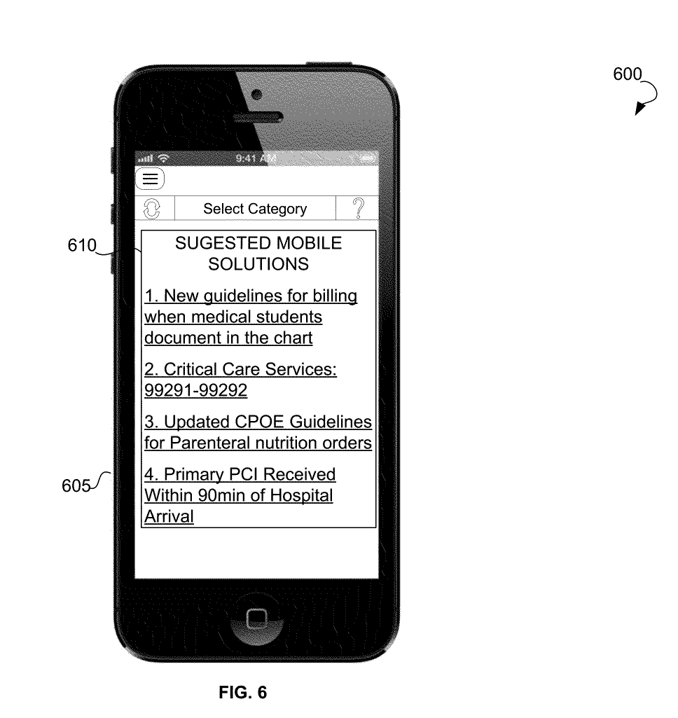

FIG. 6 shows a schematic diagram 600 of an example list of mobile solutions suggested to the user on a mobile device. More specifically, the mobile application launched in the mobile device 605 may provide a list 610 of mobile solutions that are relevant to the current practice setting of the user. Additionally, user parameters may be taken into account, such as role, specialty, user profile data, user performance, organization parameters, such as performance scores, quality scores, local positioning context, and so forth.

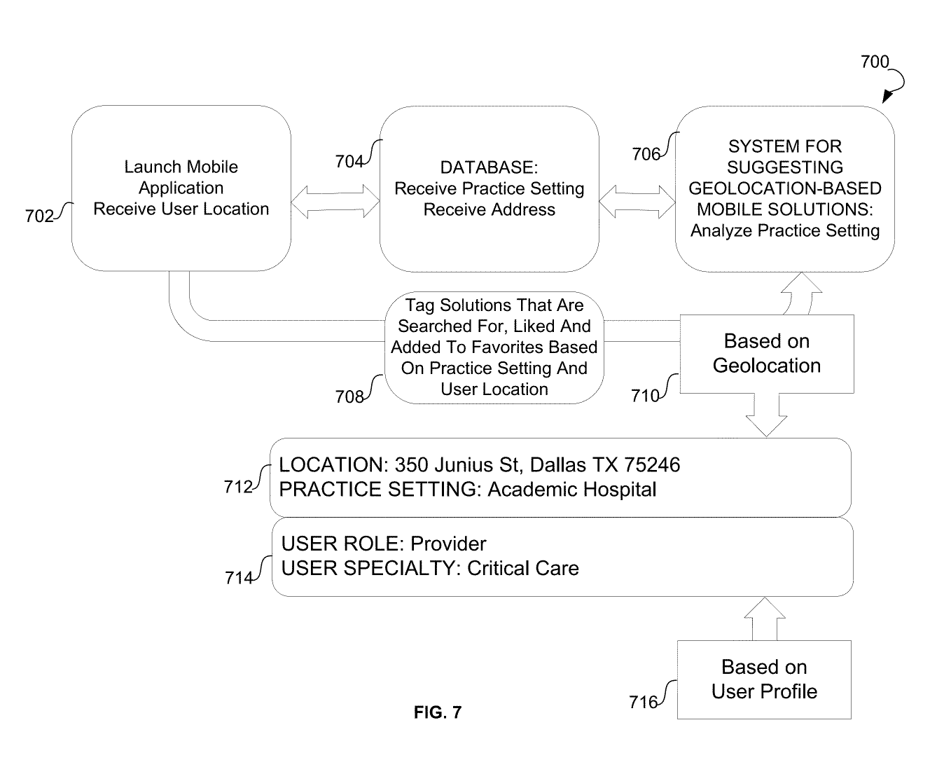

FIG. 7 shows a schematic diagram 700 of tagging mobile solutions. The current location of the user may be matched with the database to determine the current practice setting, as shown in blocks 702 and 704. Based on the analysis performed based on the location and the practice setting, e.g., an academic hospital, a specific mobile solution may be provided to the user, as shown in block 706. More specifically, the analysis may be performed based on geolocation of the user, as shown in blocks 710 and 712, and based on a user profile, as shown in blocks 714 and 716. In some example embodiments, the analysis may be further based on publicly reported quality scores or performance scores associated with the organization, as well as local positioning context provided by local positioning tools, such as iBeacons. The analysis may be further based on factors or variables associated with the size of the organization, such as the number of affiliated physicians, and number of beds. Based on user parameters, for example, settings of the user profile, such as role of the user (e.g., provider), specialty of the user (e.g., critical care), user performance (e.g., central line infection rates), and the like, another specific mobile solution may be provided to the user. The user may “Like” the mobile solution or add the mobile solution to a favorite list of mobile solutions. The liked and favorited mobile solutions may be tagged to the practice setting of the user, as shown in block 708. The tagged mobile solutions may be suggested in future for further users having similar practice settings.

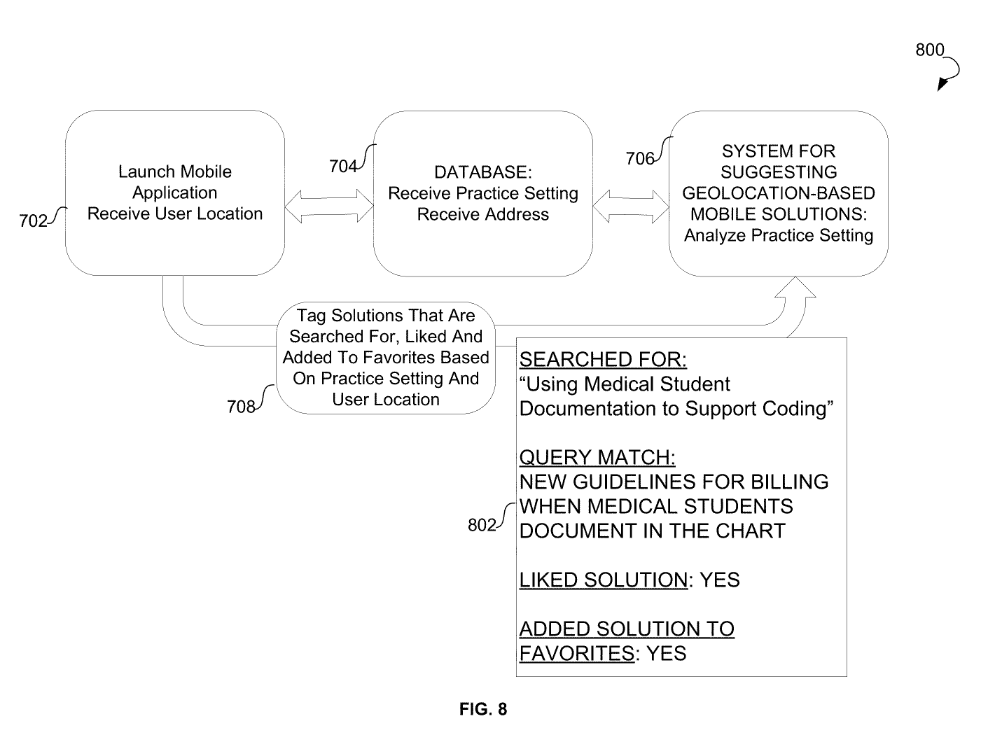

FIG. 8 is a schematic diagram 800 showing a search for a mobile solution, according to an example embodiment. The user may provide a search request for a specific mobile solution (for example, related to a particular topic with the assumption that the particular topic is relevant to current practice setting of the user). The user search request may include a voice search, a text search, a key word search, key questions, and the like. The user can also browse for a particular mobile solution based on the current needs of the user. If a match is found, the results of the search may be registered for the requested mobile solution, based on the current practice setting of the user. Furthermore, if the mobile solution is “Liked” by the user, the mobile solution is registered for the search request of the user, based on the current practice setting of the user, organization parameters, or local positioning context. Additionally, if the mobile solution is added to the favorite list of mobile solutions of the user, the mobile solution is registered for the user search request, based on the current practice setting of the user. Block 802 shows an example search request and the match found for the search.

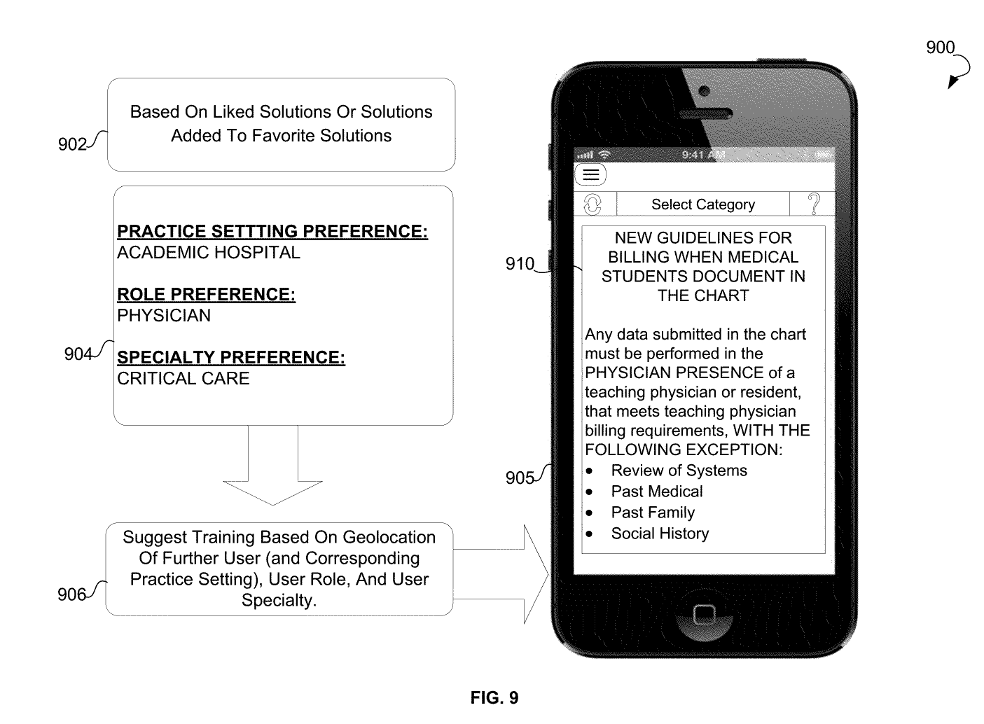

FIG. 9 is a schematic diagram 900 showing suggesting a mobile solution to further users. The system for suggesting geolocation-based mobile solutions captures information related to “Liked” mobile solutions and mobile solutions added to a favorite list of mobile solutions, as shown in block 902. Such information is used in the future to suggest mobile solutions to further users, whose practice setting and other further user parameters, such as role, specialty, user performance, and the like, match practice setting and user parameters of the user, as shown in blocks 904 and 906. Additionally, quality scores or performance scores associated with an organization and local positioning context, such as the local positioning context provided via iBeacons (for example, high rates of infections in a specific unit within a location of a hospital or within the practice setting), may be used to select and suggest mobile solutions to further users. Thus, the suggested mobile solution 910 may be shown to the further user on a mobile device 905 associated with the further user. Therefore, users from different organizations in different parts of the world may have access to the same library of mobile solutions, and, although the locations of the users are different, the practice settings may be the same and therefore may be the common denominator used to suggest the mobile solution to users from different locations with the same practice settings.

Although users and mobile solutions related to healthcare are mentioned, the use of a current location and cross referencing the current location of the user with practice settings or user parameters, such as user work settings, to filter and suggest mobile solutions can be applied to many other industries.

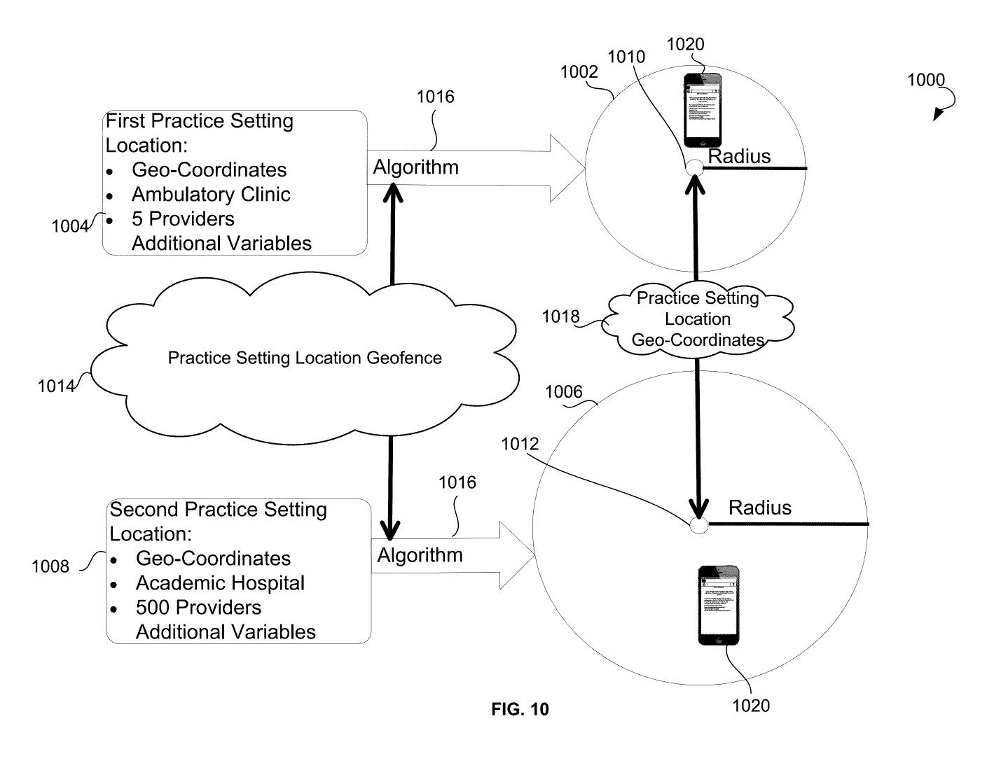

FIG. 10 is a schematic diagram 1000 showing dynamic creation of a geofence for a specific location and associated practice setting. The geofence may include a virtual perimeter in a real-world geographic area. The system for suggesting geolocation-based mobile solutions may be used to determine the radius size of the geofence. When a learner uses the mobile application on a mobile device 1020, the system may receive geographical coordinates of the learner, and then match the geographical coordinates with a database containing all of the geofences to determine the current practice setting of the learner. In other words, the location of the learner may be matched to the practice setting based on a geofence. The match can be used and included as a tag for all “liked” and “favorited” mobile solutions, as well as to drive the suggestion of mobile solutions as previously described. The system can use practice location variables, such as a practice setting, number of associated providers, and other variables, to define the radius size used to automatically calculate the appropriate geofence for the location based on central geographical coordinates of the current practice setting of the learner. Eventually, the system may include an administration page that may allow modifying the radius size of the geofence and/or free-hand drawing or editing the geofence. The geofence may be dynamically adjusted based on quality scores or performance scores associated with an organization and based on the local positioning context provided by the local positioning tools, such as iBeacons.

More specifically, a circular geofence can be used around the central geographical coordinates of the practice setting location. As shown on the schematic diagram 1000, a circular geofence 1002 may be used for a first practice setting location 1010, and a circular geofence 1006 may be used for a second practice setting location 1012. The circular circumference (diameter/radius) of the circular geofence 1002 and circular geofence 1006 may be dynamically adjusted based on the type of practice setting and additional parameters for the site, such as variables that characterize a size associated with a hospital or a clinic (i.e., number of physicians, a number of staffed beds, eligible providers, and so forth). For instance, block 1004 shows parameters associated with the first practice setting location 1010. For example, an ambulatory practice with less than 10 providers is usually in a small location; therefore, the geofence 1002 having a radius of 50 yards may be used. For instance, block 1008 shows parameters associated with the second practice setting location 1012. For example, for an academic center with more than 500 providers, the circular geofence 1006 having a radius of 500 yards may be used. In an example embodiment, the size of the circular geofence 1002 and the circular geofence 1006 may be calculated using a predetermined algorithm 1016. Data associated with circular geofence 1002 of the first practice setting location 1010 and circular geofence 1006 of the second practice setting location 1012 may be stored in a database 1014. Furthermore, data associated with geographical coordinates of the first practice setting location 1010 and the second practice setting location 1012 may be stored in a database 1018.

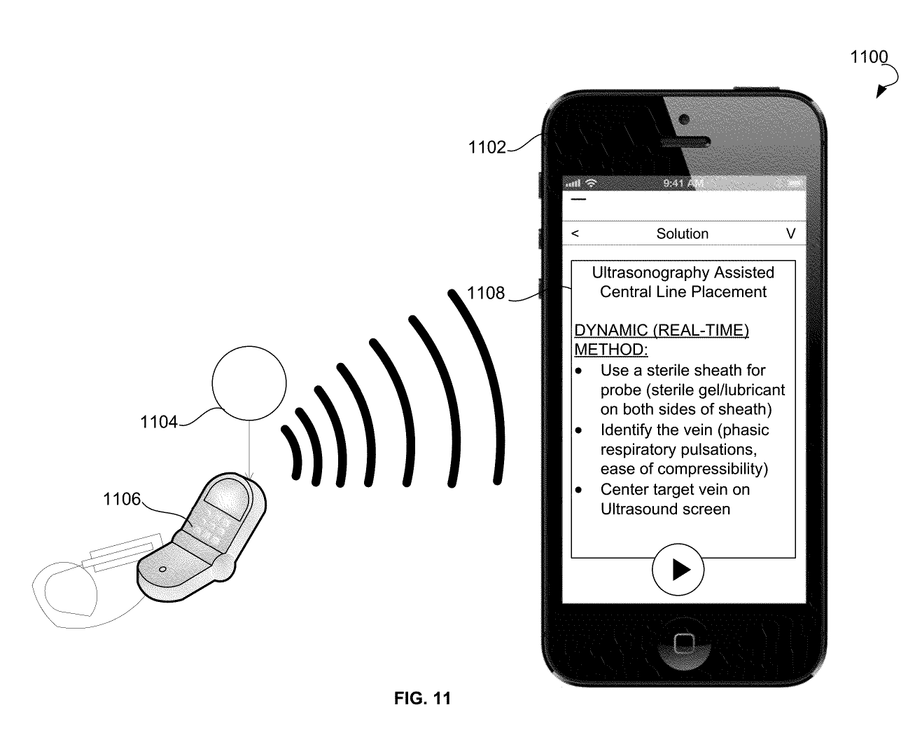

FIG. 11 shows a diagram 1100 for providing mobile solutions based on location of a user in proximity to specific items or specific locations. In an example embodiment, a mobile device 1102 associated with the user may be located close to a specific item (for example, a predefined equipment 1106) or a specific location (e.g., a location within a hospital with high rates of infections). The example predefined equipment 1106 may include an ultrasonic scanner, as shown on the diagram 1100. The predefined equipment 1106 may be provided with a beacon 1104, such as an iBeacon. In an example embodiment, the beacon 1104 uses Bluetooth low energy proximity sensing to transmit an identifier that can be received by a compatible application or operating system. The identifier and data sent with the identifier can be used to determine the location of the beacon 1104. The mobile device 1102 may receive a signal from the beacon 1104. The mobile device 1102 may further send an indication to the system for suggesting geolocation-based mobile solutions that the mobile device 1102 is located in proximity to the predefined equipment. Based the received indication, the system for suggesting geolocation-based mobile solutions may select a mobile solution 1108 associated with the predefined equipment. The system for suggesting geolocation-based mobile solutions may further provide the selected mobile solution 1108 to the user using the mobile device 1102.

Therefore, users located close to specific equipment, such as near newly purchased medical equipment and the like, may receive targeted medical solutions on how to most effectively use the specific equipment. The medical solutions may include basic troubleshooting instructions, as well as specific guidelines for safe use of the medical equipment. Furthermore, users located in a close proximity of a specific location provided with a beacon, such as a critical care unit within a hospital with high rates of infections, may receive targeted medical solutions on how to behave within the specific location.

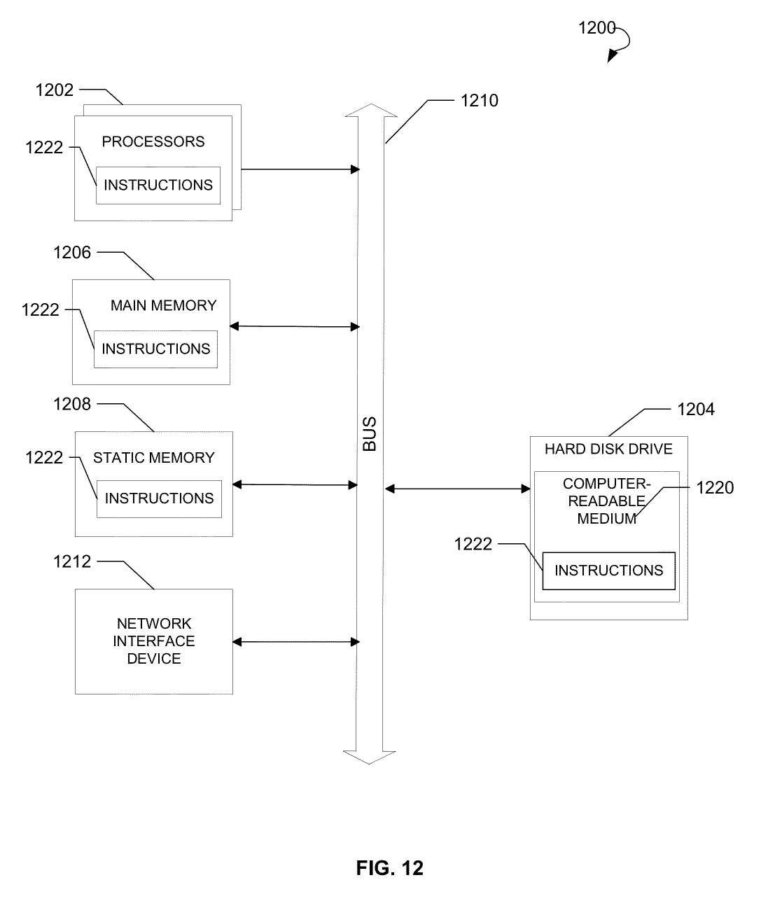

FIG. 12 shows a diagrammatic representation of a computing device for a machine in the exemplary electronic form of a computer system 1200, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a cellular telephone, a portable music player (e.g., a portable hard drive audio device, such as an Moving Picture Experts Group Audio Layer 3 player), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1200 includes a processor or multiple processors 1202, a hard disk drive 1204, a main memory 1206, and a static memory 1208, which communicate with each other via a bus 1210. The computer system 1200 may also include a network interface device 1212. The hard disk drive 1204 may include a computer-readable medium 1220, which stores one or more sets of instructions 1222 embodying or utilized by any one or more of the methodologies or functions described herein. The instructions 1222 can also reside, completely or at least partially, within the main memory 1206 and/or within the processors 1202 during execution thereof by the computer system 1200. The main memory 1206 and the processors 1202 also constitute computer-readable medium 1220.

While the computer-readable medium 1220 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random-Access Memory, Read Only Memory, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, C++, C# or other compilers, assemblers, interpreters or other computer languages or platforms.

Thus, systems and methods for suggesting geolocation-based mobile solutions are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A system for suggesting geolocation-based mobile solutions, the system comprising:
a processor operable to:
receive a location associated with a mobile device;
match the location to a practice setting in a database;
ascertain user parameters associated with a user of the mobile device; and
based on the practice setting and the user parameters, suggest at least one mobile solution; and
the database comprising computer-readable instructions for execution by the processor.

2. The system of claim 1, wherein the processor is further operable to:
ascertain organization parameters associated with the location, wherein the organization parameters include one or more of the following: a quality score associated with an organization, a performance score associated with the organization, and a local positioning context, wherein the local positioning context is provided via local positioning devices, and wherein the suggesting of the at least one mobile solution is further based on the organization parameters.

3. The system of claim 1, wherein the practice setting includes at least one of the following: an academic hospital, a rural hospital, an ambulatory clinic, a rehabilitation center, a specialization field of the user, an area of practice of the user, user performance, and a sub-population of patient population.

4. The system of claim 1, wherein the suggesting of the at least one mobile solution includes matching the user parameters to further user parameters associated with the practice setting, wherein the further user parameters correspond to further users associated with the practice setting irrespective of a location of the further users.

5. The system of claim 1, wherein the user parameters include one or more of the following: a user role, a user specialty, user performance, an initial setup, a number of logins, historical user input, user preferences, user favorites, user likes, and user tags.

6. The system of claim 1, wherein the location associated with the mobile device is received via location services associated with the mobile device.

7. The system of claim 1, wherein the at least one mobile solution includes a training.

8. The system of claim 1, wherein the processor is further operable to:
receive a search request from the user;
if a search match is found, register the search match for the mobile solution based on the practice setting associated with the user and organization parameters;
if the mobile solution is liked by the user, register the mobile solution for the mobile device based on the practice setting associated with the user and organization parameters; and
if the mobile solution is added to a favorite list of mobile solutions, register the mobile solution based on the practice setting associated with the user and organization parameters.

9. The system of claim 1, wherein the processor is further operable to identify at least one learner matching the practice settings and the user parameters.

10. The system of claim 9, wherein the processor is further operable to suggest the at least one mobile solution to the at least one learner based on preferences of further users with similar parameters.

11. The system of claim 1, wherein the location is matched to the practice setting based on a geofence, the geofence being associated with geographical coordinates of a location associated with the practice setting.

12. The system of claim 1, wherein the processor is further operable to:
receive an indication from the mobile device that the mobile device is located in proximity to a predefined equipment or a predetermined location; and
select the at least one mobile solution, wherein the at least one mobile solution is associated with the predefined equipment or a predetermined location.

13. A method for suggesting geolocation-based mobile solutions, the method comprising:
receiving a location associated with a mobile device;
matching the location to a practice setting in a database;
ascertaining user parameters associated with a user of the mobile device; and
based on the practice setting and the user parameters, suggesting at least one mobile solution.

14. The method of claim 13, further comprising receiving, from the mobile device, indicia of a mobile application being launched.

15. The method of claim 13, wherein the practice setting includes at least one of the following: an academic hospital, a rural hospital, an ambulatory clinic, a rehabilitation center, a specialization field of the user, an area of practice of the user, user performance, and a sub-population of patient population.

16. The method of claim 13, wherein the suggesting the at least one mobile solution includes matching the user parameters to further user parameters associated with the practice setting, wherein the further user parameters correspond to further users associated with the practice setting irrespective of the location.

17. The method of claim 13, further comprising:
receiving a search request from the user;
if a search match is found, registering the search match for the mobile solution based on the practice setting associated with the user and organization parameters;
if the mobile solution is liked by the user, registering the mobile solution for the mobile device based on the practice setting associated with the user and organization parameters; and
if the mobile solution is added to a favorite list of mobile solutions, registering the mobile solution based on the practice setting associated with the user and organization parameters.

18. The method of claim 13, further comprising identifying at least one learner matching the practice settings and the user parameters, the at least one mobile solution based on preferences of further users with similar parameters.

19. The method of claim 18, further comprising suggesting the at least one mobile solution to the at least one learner based on preferences of further users with similar parameters.

20. A system for suggesting geolocation-based mobile solutions, the system comprising:
a processor operable to:
receive, from a mobile device, indicia of a mobile application being launched;
receive a location associated with the mobile device;
match the location to a practice setting in a database;
ascertain user parameters associated with a user of the mobile device;
ascertain organization parameters associated with the location, wherein the organization parameters include one or more of the following: a quality score associated with an organization, a performance score associated with the organization, and a local positioning context, wherein the local positioning context is provided via local positioning devices;
based on the practice setting, the user parameters and the organization parameters, suggest at least one mobile solution;
receive a search request from the user;
if a search match is found, register the search match for the mobile solution based on the practice setting associated with the user and the organization parameters;
if the mobile solution is liked by the user, register the mobile solution for the mobile device based on the practice setting associated with the user and the organization parameters;
if the mobile solution is added to a favorite list of mobile solutions, register the mobile solution based on the practice setting associated with the user and the organization parameters; and
suggest the at least one mobile solution to the at least one learner based on preferences of further users with similar parameters, wherein the location is matched to the practice setting based on a geofence, the geofence being associated with central geographical coordinates of a location of the practice setting; and
the database comprising computer-readable instructions for execution by the processor.
